(19) United States
(12) Patent Application Publication
(10) Pub. No.: US 2013/0287900 A1
(43) Pub. Date: Oct. 31, 2013

(54) SUCROSE COMPOSITION

(71) Applicant: HEBEI TIANBANLU SCIENCE AND TECHNOLOGY CO., LTD., Shijiazhuang (CN)

(72) Inventors: Quanjun GAO, Shijiazhuang (CN); Jing GAO, Shijiazhuang (CN); Meng ZHAO, Shijiazhuang (CN)

(21) Appl. No.: 13/925,784

(22) Filed: Jun. 24, 2013

Related U.S. Application Data
(63) Continuation-in-part of application No. PCT/CN2011/002142, filed on Dec. 20, 2011.

(30) Foreign Application Priority Data
Dec. 27, 2010 (CN) 201010606277.0

(51) Int. Cl. A23L 1/236

(52) U.S. Cl. CPC A23L 1/2363
USPC 426/72; 426/658; 426/311

(57) ABSTRACT

A sucrose composition including: a base material, a sweetener, a nutrient, and a stabilizer. The base material includes sucrose and lactosucrose. The sweetener includes sucralose. The nutrient includes an organic selenium or/and vitamin C. The stabilizer includes a maltodextrin. The weight parts of the above raw materials are as follows: sucrose: between 1 and 95; lactosucrose: between 5 and 99; sucralose: between 0.0033 and 5.416; the organic selenium: between 0 and 0.015; vitamin C: between 0 and 5, and the maltodextrin: between 0 and 50. A method for preparing the sucrose composition is also provided.

### CROSS-REFERENCE TO RELATED APPLICATIONS

This application is a continuation-in-part of International Patent Application No. PCT/CN2011/002142 with an international filing date of Dec. 20, 2011, designating the United States, now pending, and further claims priority benefits to Chinese Patent Application No. 201010606277.0 filed Dec. 27, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, TX 77079.

### BACKGROUND OF THE INVENTION

1. Field of the Invention

The invention relates to a sweetener, and more particularly to a low-calorie, nutritional sucrose composition.

2. Description of the Related Art

As an important sweetening agent, sucrose has pure taste and convenient consumption means. However, sucrose has high calorie value, and excessive consumption thereof easily causes obesity, tooth decay, and other diseases. In addition, sucrose is highly hydroscopic and is easy to form caking, which shortens its shelf life. Although high sweetness of sweeteners and sugar substitutes are available on the market, they are lack of nutrition and have poor taste, even some have hidden danger, and high production cost resulting from shortage of raw materials, thereby being not suitable for industrial production.

### SUMMARY OF THE INVENTION

In view of the above-described problems, it is one objective of the invention to provide a low-calorie, nutritional sucrose composition. The sucrose composition employs natural sugarcane, sugar beet, or derivatives thereof as raw materials, retains original taste and convenient consumption means, and has low heat quantity, improved functions of bifidus factor and anti-dental caries, and it is safe for consumption. The raw materials are sufficient for mass production, capable of preventing dental caries and other diseases resulting from excessive consumption of sugar, and overcome shortages that an intensive sweetener contains no nutrient and lactosucrose has a low saccharinity and high production cost. In addition, the raw materials contain health factors and micronutrient, so that the sucrose composition is beneficial to the public health. The low-calorie, nutritional sucrose composition is highly stable, convenient for consumption, and applicable to different populations.

To achieve the above objective, in accordance with one embodiment of the invention, there is provided a low-calorie, nutritional sucrose composition. The sucrose composition comprises the following raw materials: a base material comprising sucrose and lactosucrose; a sweetener comprising sucralose; a nutrient comprising an organic selenium or/and vitamin C; and a stabilizer comprising a maltodextrin. The weight parts of the above raw materials are as follows:

| | |
|---|---|
| sucrose | 1-95, |
| lactosucrose | 5-99, |
| sucralose | 0.0033-5.416, |
| the organic selenium | 0-0.015, |
| vitamin C | 0-5, and |
| the maltodextrin | 0-50. |

In a class of this embodiment, the weight parts of the base material, the sweetener, the nutrient, and the stabilizer are as follows:

| | |
|---|---|
| sucrose | 30-70, |
| lactosucrose | 30-70, |
| sucralose | 0.02-1.2535, |
| the organic selenium | 0-0.0005, |
| vitamin C | 0-1.0, and |
| the maltodextrin | 0-25. |

The lactosucrose is manufactured by mixing 13-fructosaccharase, lactose, and sucrose. The saccharinity of the lactosucrose is 0.5-0.7 times that of sucrose; and the heat quantity of the saccharinity is 50% lower than that of sucrose. As a synthetic oligosaccharide, the lactosucrose is functioned as a bifidus factor, which is capable of decreasing the possibility of dental caries, facilitating the growth of bifidobacteria inside the intestine, and maintaining the microeubiosis in the body.

As a non-nutritional intensive sweetener, sucralose is a derivative of sucrose prepared by using halogen to substitute sucrose and belongs to a natural sweetener. Sucralose has pure sweet taste; the sweetness curve of sucralose almost overlaps with that of sucrose, and the saccharinity of sucralose is 600-650 times that of sucrose. Sucralose does not participate in metabolism inside the body, it has a zero heat quantity, and the stability for anti-acid hydrolysis of the sucralose is 10 times higher than that of sucrose. Besides, sucralose has a high safety and no-side effect; it is capable of effectively preventing dental caries, and suitable for different populations including patients suffering diabetes, obesity, and cardiovascular diseases and is a perfect and competitive sweetener being widely popularized by the FAO and the WHO.

The organic selenium or/and vitamin C are employed as a nutrient. An appropriate content of selenium and vitamin C is beneficial to prevent diseases and delay senility. A daily intake amount of selenium should not exceed 800 μg for each person, which otherwise results in selenosis, thus, the content of the organic selenium is limited within the range of 0-0.015 weight part. A daily intake amount of vitamin C should not exceed 75 mg for each person, which otherwise leads to oxalate and uric acid calculus, plasmorrhexis, and hemolysis. Thus, the content of the vitamin C is limited within between 0 and 5.0 weight parts. The dosage of the nutrient is adjusted according to the saccharinity of the sucrose composition.

As a stabilizer, the maltodextrin is capable of lowering the viscocity of sucrose and the lactosucrose, lowering hydroscopicity, increasing the mobility, and prolonging the shelf life.

Specifically, the raw materials for preparing the sucrose composition and weight parts thereof are as follows: 70 weight parts of sucrose, 30 weight parts of the lactosucrose, and 0.02 weight part of sucralose. A saccharinity of the sucrose composition is the same as that of sucrose.

Optionally, the raw materials for preparing the sucrose composition and weight parts thereof are as follows: 95 weight parts of sucrose, 5 weight parts of the lactosucrose, and 0.0033 weight part of sucralose. A saccharinity of the sucrose composition is the same as that of sucrose.

A method for preparing the low-calorie, nutritional sucrose composition comprises: evenly mixing the raw materials, and grinding, granulating, and drying a resulting mixture, respectively, to yield the sucrose composition.

The method of the invention has a simple process and convenient operation. Products of the sucrose composition are in the form of uniform and smooth crystals, and have properties of low viscocity, low hydroscopicity, thereby prolonging the shelf life of the products. Sucrose compositions of different saccharinities and different heat quantities can be prepared by adjusting the weight parts of the raw materials.

Compared with the prior arts, advantages of the invention are as follows:

Products of the sucrose composition of the invention features pure taste, safety, low heat quantity, and being nutritional and healthy. It retains the nutrient, taste, and consumption means of original sucrose and prevents dental caries resulting from high heat quantity, and diseases due to excessive consumption. The sucrose composition is beneficial to maintain the microeubiosis inside the intestine, facilitate the adsorption of micronutrient and mineral substances, and prevent intestinal diseases and other complications thereby being good to health and delay senility. The raw materials for manufacturing the sucrose composition are cheap, and suitable for mass production; besides, the taste, nutrient, and price are easily acceptable by the public. When enjoying the pure taste, health factors and necessary micronutrient are taken into the body, so that the energy and immunity of the body is improved, the microeubiosis is adjusted, and the public health is improved.

Because sucralose and the lactosucrose have low hydroscopicity, products prepared by mixing, grinding, granulating, and drying the raw materials are in the form of uniform and smooth crystals, and have properties of low viscocity, low hydroscopicity, thereby prolonging the shelf life of the products. The sucrose compositions of different saccharinities and different heat quantities can be prepared by adjusting the weight parts of the raw materials.

The sucrose composition of the invention can be used either as a sweetener in the food production process, or be consumed directly.

### DETAILED DESCRIPTION OF THE EMBODIMENTS

To further illustrate the invention, experiments detailing a low-calorie, nutritional sucrose composition and a method for preparing the same are described below. It should be noted that the following examples are intended to describe and not to limit the invention.

Examples 1-9 describe a low-calorie, nutritional sucrose composition and a method for preparing the same. The sucrose composition employs the following raw materials: a base material comprising sucrose and lactosucrose; a sweetener comprising sucralose; a nutrient comprising an organic selenium or/and vitamin C; and a stabilizer comprising a maltodextrin.

### Example 1

Provide 70 weight parts of sucrose, 30 weight parts of lactosucrose, and 0.02 weight part of sucralose as raw materials. Evenly mix the raw materials, and grind, granulate, and oven dry a resulting mixture to yield a low-calorie, nutritional sucrose composition. The saccharinity of the sucrose composition is the same as that of sucrose.

### Example 2

Provide 95 weight parts of sucrose, 5 weight parts of lactosucrose, and 0.0033 weight part of sucralose as raw materials. Evenly mix the raw materials, and grind, granulate, and oven dry a resulting mixture to yield a low-calorie, nutritional sucrose composition. The saccharinity of the sucrose composition is the same as that of sucrose.

### Example 3

Provide 20 weight parts of sucrose, 55 weight parts of lactosucrose, 25 weight parts of a maltodextrin, and 0.0783 weight part of sucralose as raw materials. Evenly mix the raw materials, and grind, granulate, and oven dry a resulting mixture to yield a low-calorie, nutritional sucrose composition. The saccharinity of the sucrose composition is the same as that of sucrose.

### Example 4

Provide 70 weight parts of sucrose, 30 weight parts of lactosucrose, 0.1867 weight part of sucralose, and 0.000125 weight part of an organic selenium as raw materials. Evenly mix the raw materials, and grind, granulate, and oven dry a resulting mixture to yield a low-calorie, nutritional sucrose composition. The saccharinity of the sucrose composition is 2 times that of sucrose.

### Example 5

Provide 10 weight parts of sucrose, 40 weight parts of lactosucrose, 50 weight parts of a maltodextrin, 0.276 weight part of sucralose, and 0.000125 weight part of an organic selenium as raw materials. Evenly mix the raw materials, and grind, granulate, and oven dry a resulting mixture to yield a low-calorie, nutritional sucrose composition. The saccharinity of the sucrose composition is 2 times that of sucrose.

### Example 6

Provide 50 weight parts of sucrose, 50 weight parts of lactosucrose, 0.5333 weight part of sucralose, and 0.5 weight part of vitamin C as raw materials. Evenly mix the raw materials, and grind, granulate, and oven dry a resulting mixture to yield a low-calorie, nutritional sucrose composition. The saccharinity of the sucrose composition is 4 times that of sucrose.

### Example 7

Provide 15 weight parts of sucrose, 85 weight parts of lactosucrose, 1.2535 weight parts of sucralose, 0.0005 weight part of an organic selenium, and 1.0 weight part of vitamin C as raw materials. Evenly mix the raw materials, and grind, granulate, and oven dry a resulting mixture to yield a low-calorie, nutritional sucrose composition. The saccharinity of the sucrose composition is 8 times that of sucrose.

### Example 8

Provide 1 weight part of sucrose, 99 weight parts of lactosucrose, 5.416 weight parts of sucralose, 0.015 weight part of an organic selenium, and 5 weight parts of vitamin C as raw materials. Evenly mix the raw materials, and grind, granulate, and oven dry a resulting mixture to yield a low-calorie, nutritional sucrose composition. The saccharinity of the sucrose composition is 30 times that of sucrose.

### Example 9

Provide 30 weight parts of sucrose, 70 weight parts of lactosucrose, 1.588 weight parts of sucralose, 0.000625 weight part of an organic selenium, and 0.9 weight part of vitamin C as raw materials. Evenly mix the raw materials, and grind, granulate, and oven dry a resulting mixture to yield a low-calorie, nutritional sucrose composition. The saccharinity of the sucrose composition is 8 times that of sucrose.

Products obtained from the above examples are odorless and soluble in water. They have appearance and taste that are more or less the same as sucrose, lower heat quantity than sucrose, and much healthier than sucrose. Sucrose composition of the invention can be a substitute of sucrose of high-calorie used in catering and food processing industry. Consumption methods of sucrose composition are the same as the conventional consumption methods of sucrose, and the dosage of sucrose composition is adjusted according to the saccharinity.

1. A sucrose composition, comprising:
a) a base material, said base material comprising sucrose and lactosucrose;
b) a sweetener, said sweetener comprising sucralose;
c) a nutrient, said nutrient comprising an organic selenium or/and vitamin C; and
d) a stabilizer, said stabilizer comprising a maltodextrin;
wherein the following components are provided in the following weight parts:

| | |
|---|---|
| sucrose | 1-95; |
| lactosucrose | 5-99; |
| sucralose | 0.0033-5.416; |
| the organic selenium | 0-0.015; |
| vitamin C | 0-5; and |
| the maltodextrin | 0-50. |

2. The sucrose composition of claim 1, wherein the following components are provided in the following weight parts:

| | |
|---|---|
| sucrose | 30-70; |
| lactosucrose | 30-70; |
| sucralose | 0.02-1.2535; |
| the organic selenium | 0-0.0005; |
| vitamin C | 0-1.0; and |
| the maltodextrin | 0-25. |

3. The sucrose composition of claim 1, wherein the following components are provided in the following weight parts:

| | |
|---|---|
| sucrose | 95; |
| lactosucrose | 5; and |
| sucralose | 0.0033. |

4. The sucrose composition of claim 1, wherein the following components are provided in the following weight parts:

| | |
|---|---|
| sucrose | 70; |
| lactosucrose | 30; and |
| sucralose | 0.02. |

5. A method for preparing the sucrose composition of claim 1, the method comprising: evenly mixing the raw materials, and grinding, granulating, and drying a resulting mixture, respectively, to yield the sucrose composition.
